(19) United States
(12) Patent Application Publication
(10) Pub. No.: US 2024/0264610 A1
(43) Pub. Date: Aug. 8, 2024

(54) IMPLEMENT ATTACHMENT SYSTEM FOR AUTONOMOUS MODULAR GROUND UTILITY ROBOT SYSTEM

(71) Applicant: DCENTRALIZED SYSTEMS LLC, Seattle, WA (US)

(72) Inventor: Georgios Chrysanthakopoulos, Seattle, WA (US)

(73) Assignee: DCENTRALIZED SYSTEMS LLC, Seattle, WA (US)

(21) Appl. No.: 18/641,242

(22) Filed: Apr. 19, 2024

Related U.S. Application Data
(63) Continuation-in-part of application No. 16/405,282, filed on May 7, 2019, now Pat. No. 11,991,942.
Application No. 16/405,282 is a continuation-in-part of application No. 16/024,450, filed on Jun. 29, 2018, now Pat. No. 10,863,668.
Application No. 16/024,450 is a continuation-in-part of application No. 29/665,575, filed on Oct. 4, 2018, now Pat. No. D918977.
Application No. 29/665,575 is a continuation-in-part of application No. PCT/US2018/067458, filed on Dec. 24, 2018.
(60) Provisional application No. 62/820,375, filed on Mar. 19, 2019.
(60) Provisional application No. 62/612,297, filed on Dec. 29, 2017.

(51) Int. Cl. G05D 1/667; B60D 1/24; G05D 1/622; G05D 101/15; G05D 105/15; G05D 105/80; G05D 107/20

(52) U.S. Cl. CPC G05D 1/667; B60D 1/24; G05D 1/622; G05D 2101/15; G05D 2105/15; G05D 2105/80; G05D 2107/21

(57) ABSTRACT

An automatic implement attachment and detachment system having a ground utility robot a sensor, a computer processor, an artificial intelligence processing unit for learning, and a computer memory where the system also includes a quick hitch attachment apparatus having a body securable to the ground utility robot, at least one mateable connection part, and an implement having a connection member where the implement attachment system is configured to automatically attach and detach the implement to and from the ground utility robot.

### RELATED APPLICATIONS

This application is a Continuation-in-Part application of the co-pending U.S. non-provisional patent application Ser. No.: 16/405,282, filed 2019 May 07, entitled IMPLEMENT ATTACHMENT SYSTEM FOR AUTONOMOUS MODULAR GROUND UTILITY ROBOT SYSTEM. This application claims the benefit of U.S. provisional patent application Ser. No.: 62/612,297, filed 2017 Dec. 29 and entitled AUTONOMOUS MODULAR GROUND UTILITY ROBOT SYSTEM; U.S. non-provisional patent application Ser. No.: 16/024,450 filed 2018 Jun. 29 entitled AUTONOMOUS MOBILE PLATFORM WITH HARVESTING SYSTEM AND PEST AND WEED SUPPRESSION SYSTEMS; U.S. Design Patent Application Ser. No. 29/665,575, filed 2018 Oct. 04, entitled AUTONOMOUS MOBILE PLATFORM; previously filed PCT application number PCT/US2018/067458 filed on 2018 Dec. 24; and previously filed U.S. Provisional patent application, Ser. No.: 62/820,375 all incorporated herein by reference.

### FIELD OF THE INVENTION:

The current invention relates to the field of autonomous, modular, ground utility robots that can be used to perform a variety of tasks and that ideally use dean sources of energy to power the devices and their apparatus. More specifically, it relates to an autonomous, cooperative machine, in the form of a ground utility robot with artificial intelligence, that is deployed for service work and that performs and learns a variety of tasks or functions, More specifically still, it relates to a system working in conjunction with the ground utility robot to learn to engage and disengage accessories and implements, such as movers, combines, plows, and the like to and from the robot, using a hitch system.

### BACKGROUND INFORMATION:

There is a great need to have robots assist in our daily lives. As technology advances it is now envisionable that robots can and will perform many of the mundane tasks and chores that we as humans routinely perform in our daily lives. Already used abundantly in manufacturing, the personal “bot” has not quite made it into our lives much past the Roomba® cleaner by iRobot®. There are multitudes of applications for a mobile robot, including but not limited to snow removal, transporter, ground aeration, plant watering, feeding and fertilizing, crop monitoring, corn de-tasseling, crop harvesting which might include picking beans, berries, apples, pears, grapes, etc., grounds security, weather reporting, livestock surveillance and monitoring (for example, if an animal in the pasture is sick or injured the bot could report back to the farmer that there is a problem), debris cleanup and removal and a variety of other tasks and chores now performed by humans. Thus, there is a need to have bots assist us in our daily lives. Furthermore, many of these functions require attaching an accessory or implement to the robot to perform the task. Additionally, there has been an increase in use of artificial intelligence, assisting us in many tasks, and artificial intelligence is currently becoming integrated into many of the systems and machines we use daily. This invention provides an easy, automatic means of engaging and disengaging the accessory or implement to and from the ground utility robot that uses artificial intelligence to learn about its environment, that will learn to recognize different accessories, that will learn how to connect and disconnect a variety of accessories, that works in an unstructured environment and that ultimately does not require any human interface or assistance to perform these tasks, chores, connecting and disconnecting.

### SUMMARY OF THE INVENTION:

The invention is an implement mating, attachment and detachment system for use with a ground utility robot, working and continuously learning through artificial intelligence in an unstructured environment, that automatically couples and decouples implements, accessories and attachments to and from the ground utility robot using a mating interface.

### DESCRIPTION OF THE FIGURES

FIG. 1 is a perspective view of the ground utility robot and an implement prior to engagement.

FIG. 2 is another perspective view of the ground utility robot and an implement prior to engagement.

FIG. 3 is another perspective view of the ground utility robot and an implement while the robot is picking up the implement.

FIG. 4 is another perspective view of the ground utility robot and an implement after the implement is secured to the robot.

FIG. 5 is rear perspective view of the ground utility robot and an implement after the implement is secured to the robot.

FIG. 6 is a close up of the electronically actuated locks when open.

FIG. 7 is a close up of the electronically actuated locks when closed.

FIG. 8 is a flow chart showing how the system works.

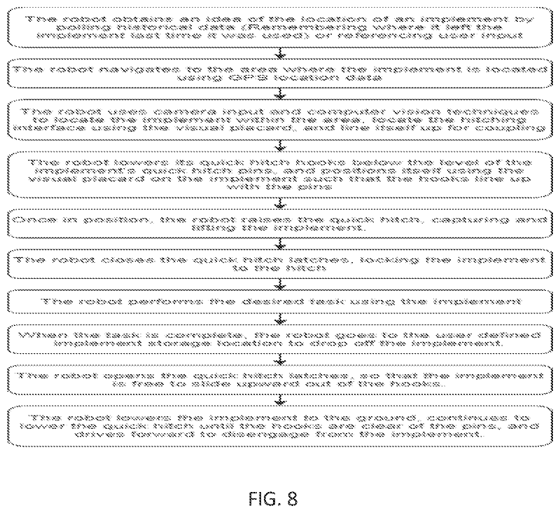

### DETAILED DESCRIPTION OF THE INVENTION:

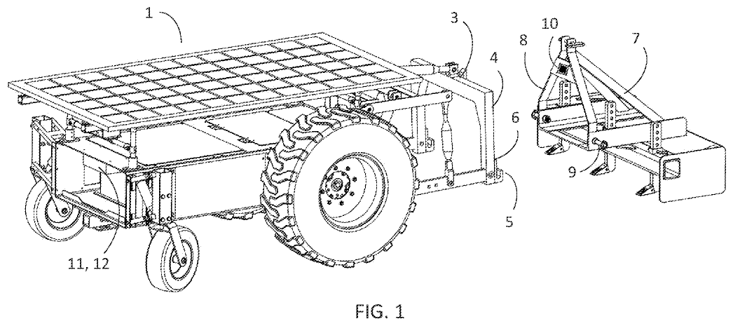

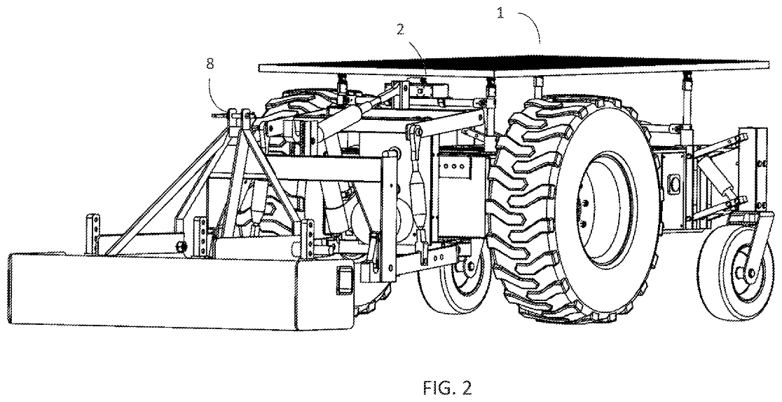

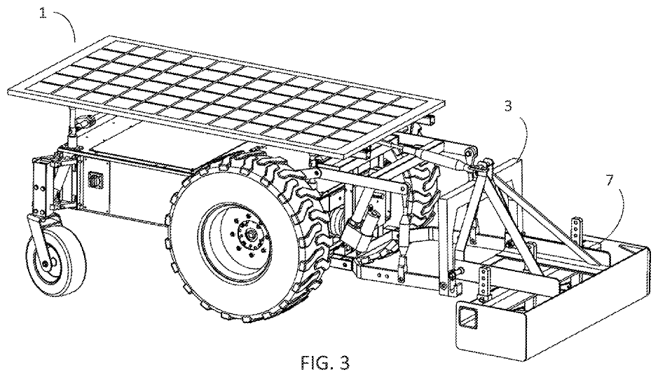

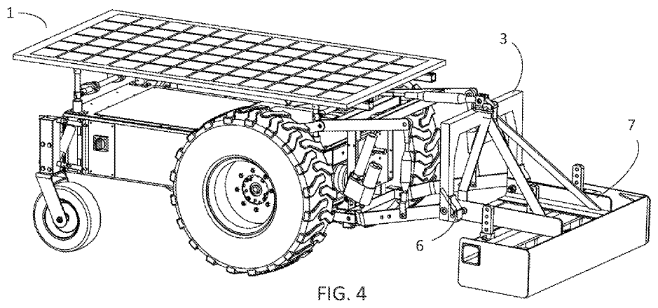

As shown in FIGS. 1-7 and flowchart 8, the present invention is a mating system for use with a ground utility robot 1 that automatically couples and decouples an implement 7, accessory or attachment to and from the ground utility robot 1 using a mating interface. One of the unique aspects of the present invention is that the robot 1 can operate in an unstructured, outdoor environments using one or multiple fused sensors. A fused sensor is basically a sensor but as a fused sensor the sensor's input is used in conjunction with other sensors to paint a cohesive picture, or map, of a sensed environment, in this case, the implement and the surroundings around the implement. The robot can then use this map created by the multiple fused inputs to navigate. The robot uses the inputs to understand its surroundings and learn from its surroundings. The current technology, on the other hand, allows for attachment to and from a robot only when the robot is located in a structured or fixed position, such as in a factory or assembly line. This is entirely different from the present invention where the entire system operates in an open, unstructured environment.

In the present invention there is an automatic implement attachment and detachment system having a ground utility robot where the robot has a computer processor for operating the ground utility robot, a computer memory for storing an artificial intelligence model and data, a sensor configured to gather data from environments encountered by the ground utility robot, and an artificial intelligence processing unit configured to train the artificial intelligence model based on received and historical data to learn to connect and disconnect an implement. Next, there is a sensor interface coupling the artificial intelligence processing unit with the sensor to provide environmental data encountered by the ground utility robot. Further, there is a quick hitch attachment apparatus having a body securable to the ground utility robot, a mateable connection part and the implement having an implement body, a connection member that is mateably connectable to the quick hitch apparatus connection part, and where the implement attachment and detachment system utilizes learned and historical data to automatically attach and detach the implement to and from the ground utility robot.

This system utilizes artificial intelligence to manage and perform tasks and chores more easily. One use is to locate the implement based on learned and historical data within the working area. The system can remember where and when an implement is dropped off, making it easy to relocate the implement when needed. Next, the system can identify the implement by utilizing historical and learned data and then can automatically attach the implement to the ground utility robot using the learned and historical data. Next, after the task or chore is completed the system must drop off the implement so that it can move on to the next task. This disconnecting also requires several steps, including searching for a location to place the implement within the working area, arriving at the location, positioning the implement for placement and then automatically detaching the implement from the ground utility robot using the learned and historical data.

The artificial intelligence processing unit of the ground utility robot is configured to direct the ground utility robot to perform at least one task. As just described, the robot 1 locates and attaches to external implements 7 in an open field, a yard, a barn or anywhere the robot 1 is required to perform a task. In this open environment the robot is instructed or requested by a user or operator or by preprogrammed command. The robot obtains an idea of the location of the implement by polling historical data, combining that historical data and learning the location. That is, remembering where it left the implement the last time it was used, or by referencing user input. The robot then navigates to the implement using GPS location data. The robot uses camera input and computer vision techniques to initially locate the implement. Once located and after instruction to engage with the implement, the robot will approach the implement 7. The robot can either connect using new information that it gathers, stores and remembers; collected and stored information; or it can detect a special identification tag 10 placed on the implement at a specific location or on a specific spot relative to the implement's coupling interface. This is ideally near the coupling location. If the identification tag 10 is used, then the robot will locate the identification tag 10 and will then line itself up to the implement 7 for attachment or coupling. Attachment is done using the following steps. The robot first lowers quick hitch hooks below the level of the implement's quick hitch connectors; it positions itself using the learned data or the stored data and/or the identification tag 10; then raises the quick hitch to capture the implement via connecting points. After attachment the robot 1 can then perform its learned task, its assigned task, such as plowing, mowing, planting, or any other task, utilizing the implement 7. When the work is complete the robot 1 can detach from the implement 7 and leaves the implement in a defined or learned location from previous activity.

This is all done safely and carefully because as the system learns it also learns its surroundings, the terrain, the obstacles and it also has instruction and continually learns how to differentiate between animate and inanimate, living and non-living things. As the robot moves about the space it constantly learns and determines the best pathway to follow. It learns where obstacles are located and then takes alternative routes around the obstacle, thus avoiding collisions. And, it learns to recognize living and non-living things so as to avoid contact and to prevent any harm.

In general, this invention is a system that over time learns a variety of implements, its surroundings, learns the terrain, learns a variety of tasks and chores, and learns to automatically connect and disconnect the implement, using a three point hitch, to the ground utility robot. Specifically, this is an automatic implement attachment and detachment system made up of a ground utility robot 1 having at least one sensor 2, a computer processor 11, and computer memory 12; a quick hitch attachment apparatus 3 having a body 4 securable to the ground utility robot 1, and at least one mateable connection part 5, where all of these connecting parts are mateable to an implement 7 where the implement 7 has at least an implement body, at least one connection member 9 that is mateably connectable to the at least one quick hitch apparatus connection part and where the implement attachment system is configured to continuously learn to automatically attach and detach the implement 7 to and from the ground utility robot 1. In this particular embodiment it is further envisioned there is a locking device 6 that can lock the at least one connection part 5 to the at least once connection member 9 after they are mateably connected. The locking device 6 can be manually operated or mechanically operated, but ideally this locking device 6 is an electronically actuated locking mechanism. In one embodiment this locking device 6 is located at two points and automatically locks the at least one connection member 9 to the at least one connection part 5 once joined.

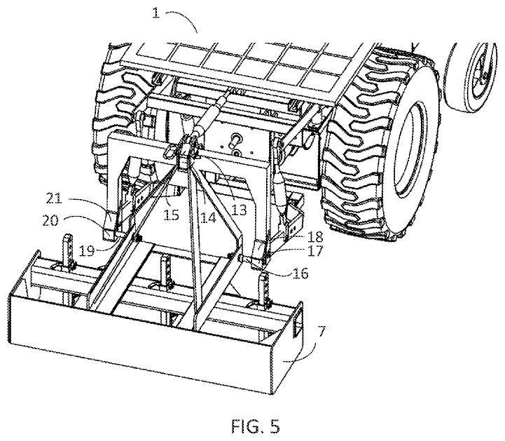

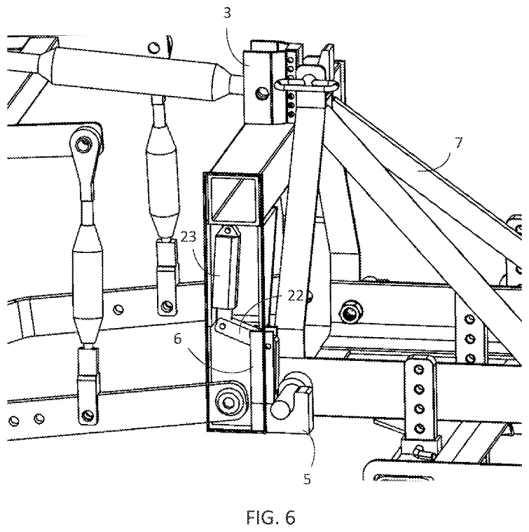

In one embodiment based on the above, the quick hitch attachment apparatus 3 has three connection points that are matingly connectable to a 3-point attachment apparatus 8 on the implement 7. This is commonly known as a 3-point hitch. In this configuration there is a first connection point 13 having a first connection part 14 located at a top of the quick hitch attachment apparatus body 4 that is connectable to a mating first connection member 15 located at a top of the implement 7. In one configuration this connection point does not lock, but in a different configuration can be lockable if desired. Rather, it is generally a type of hooking attachment where the first connection part 14 located on the quick hitch attachment apparatus 3 is a hook and the first connection member 15 is a pin or some other element that is received by or captured by the connection part 14 hook. Next, there is a second connection point 16 having a second connection part 17 located at a first lower side of the quick hitch body 4 and that is connectable to a mating second connection member 18 located at a lower first side of the implement 7. Finally, there is a third connection point 19 having a third connection part 20 located at a second lower side of the quick hitch body 4 and that is connectable to a mating third connection member 21 located at a lower second side of the implement 7. In typical operation, the second and third connection parts 17, 20 are hooks that are located on either side of the 3-point hitch quick hitch body 4 and the second and third connection members 18, 21 are pins that are located on either side of the implement 7 that are received by and then secured to or within the second and third connection parts 17, 20 of the three point hitch body, as shown in FIGS. 5 and 6.

As mentioned above, in common terms this is typically called a three-point hitch. In order to secure the quick hitch attachment apparatus 3 to the mating parts of the 3-point implement attachment apparatus, all of the connection parts need to connect to the attachment members. Also as noted above, the first connection member 15 and connection part 14 located at the top of the hitch and implement do not typically lock in place. It is usually a member that drops into a hook. The top connector typically is not locked in place but could be locked if configured to lock and this lock could also be manual or automatically activated.

However, the lower connection parts 17, 20 and connection members 18, 21 are basically the opposite configuration of parts 15, 14 where the pins are now located on the implement and are insertable to hooks on the 3-point hitch and these members should lock in place in order to prevent accidental disengagement of the implement 7 from the quick hitch attachment 3. In one embodiment these locks could be manually lockable. Ideally though, as shown in FIGS. 5 and 6, the two locks are electrically actuated locking devices 6 located at each of the two lower connecting points that automatically lock and secure the implement 7 to the body 4. These electrically actuated locking devices 6 utilize an electric linear actuator 23 and a pivoting retaining member 22.

Ideally these locking devices 6 are positioned at each of the two lower connection points 16, 19 to secure the connection parts 17, 20 and connection members 18, 21 one to another and to prohibit the implement 7 from accidental disengagement from the body 4 and the robot 1. The electronically actuated locking device 6 on the quick hitch consists of the pivoted retaining member or members 22 and the electric linear actuator member or members 23 that is controlled by the robot. It could be configured so that only one side has a locking system, but ideally the actuators and retaining members are located on both sides and at both lower connection points. When the electric linear actuator members 23 are retracted, the retaining members 22 are pivoted out of the way in order to allow the connection parts 17, 20 on the implement 7 to enter or exit the hooks, or connection members 18, 21 on the quick hitch. When the linear actuators are extended, the retaining members 22 are pivoted out and thus keep the implement locked and secured to the quick hitch as shown in FIGS. 5 and 6.

The system explained above ideally has at least one sensor 2. It is possible to have multiple sensors in order to assist the collection and storing of data so that the system can continuously learn and to continually improve and assist in the engagement/disengagement operations and these sensors could be of numerous types, such as a 3D camera, an infrared camera, a heat sensor, a microphone, or any of a variety of sensors that could assist in continual learning to facilitate connecting and disconnecting the implement 7. It is also possible to have multiple sensors to assist in learning by the artificial intelligence. In one embodiment this sensor 2 is a camera that is used to recognize the implement 7. The camera 2 is ideally placed in clear view of the implement 7 so that it can view and collect data from the area immediately around the implement and the implement 7. Data is collected, recorded and stored each time the robot 1 interacts with the implement 7 so that over time the robot can recognize the implement. All the data collected is recorded to the computer memory 12 and the processor 11 processes the data and then learns how to better recognize the implement. Ideally the data collected is processed and organized so that eventually the automatic implement attachment and detachment system will learn to automatically recognize different types of implements and that over time the system will recognize the different implements and it will then use the past collected and learned data for easily engaging, attaching and detaching the different implements to and from the system.

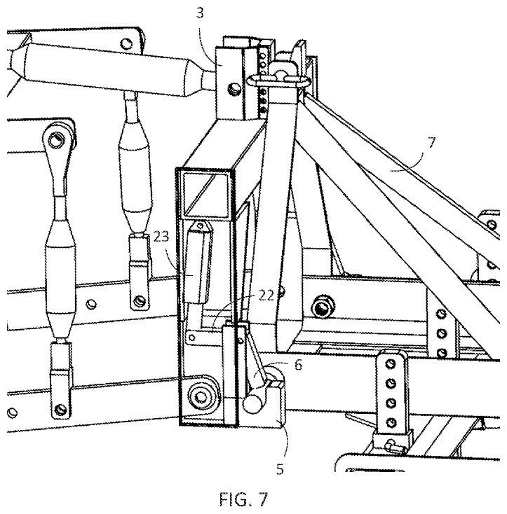

This type of system generally requires training. Using the data collected by the camera and stored within the system will help the system to learn, however, in another embodiment the system also incorporates the identification tag 10, as mentioned above and as shown in FIG. 1. This identification tag 10 is affixed or secured to the implement 7 where the tag 10 is readable by the sensor/camera 2. Like any robotic system, this invention is made up of sensing, processing, and actuating elements. The identification tags 10 that are placed on the implements 7 are designed such that they are distinct to their surroundings from the perspective of the ground utility robot's 1 sensors 2, in a range of lighting conditions, and in a range of environmental factors, including precipitation, fog, snow, rain, sleet, hail, and a plethora of other environmental factors. These tags are detectable and readable from multiple angles. Because of this, the camera 10 placement is not limited and the camera 2 may be placed in a variety of locations on the robot 1. The identification tags 10 convey encoded implement information that assists the robot while engaging and disengaging from the implement. The identification tags 10 may also appear at different scale depending on the distance from the relevant sensor 2, such that the robot 1 can derive its distance from the tag 10. FIG. 7 shows a flow chart of typical operation of the system.

In the embodiment utilizing the identification tag 10, the tag is encoded with implement specific information that is received and captured by the camera 2 whereby the camera reads the data and then transmits the data to the processor 11 and the memory 12 to enable automatic attachment and detachment of the implement 7 to and from the ground utility robot 1. After the information is received the processor 11 utilizes the identification tag information and continually combines this pre-existing, formatted data with newly acquired data that is continually compiled and uploaded to the memory 12 each time the utility robot 1 attaches and de-attaches from the implement 7 so that the memory 12 eventually has enough data to enable attachment and detachment of the implement 7 without using the identification tag 10. This learning works for every implement and eventually all implements or attachments will be connectable and disengageable without the additional data tag data or user supplied data. When this data storing and learning is accomplished the system will no longer require the data tag and it can eventually be removed from the implement.

The coupling or engagement procedure is described next. As mentioned above, the user typically initiates the command and then the robot 1 locates the specific implement desired for the chore, job or task requested. Locating the specific implement also requires artificial intelligence and learning so that the system will continually learn and remember implement locations. For example, the utility robot 1 may perform a specific task on Monday and after completion the utility robot 1 may drop off the implement at a specific location. On Tuesday the robot 1 may be instructed to perform the same task but at a different location. Because the system is continually learning, it will remember the exact location it left the implement the day before, it will return to that same location. After locating the implement 7, using either the tag 10 or learned/remembered data, the robot 1 lowers the quick hitch attachment apparatus 3 of the body 4 that has the three connection points. In one embodiment these connection parts of the body are hooks, as shown in FIGS. 1-6. The robot 1 lowers the quick hitch attachment apparatus 3 hooks below the level of the implement's quick hitch connection members. In this embodiment these connection members are pins, as clearly shown in FIGS. 1, 2, 5 and 6. The robot 1 then positions itself using the identification tag 10 data so that the hooks line up with the pins. Once in position the robot raises the quick hitch and lifts the implement 7, capturing the pins within the hooks and positioning the implement so that it can be secured in place. In other words, at each connection point, the connection members 15, 18, 21 are inserted and connected with mating connection parts 14, 17, 20 at each connection point 13, 16, 19 thus connecting and securing the implement to the quick hitch.

Once in proper position the robot 1 recognizes proper alignment and, if it is using the electronically actuated locking members 6, it sends a command to the linear actuators 23 to close the quick hitch latches with the pivoting retaining member 22, or in other words, it activates the electronically activated locking devices 6 to lock and secure the implement 7 to the robot 1, as shown in FIGS. 5 and 6. Once secured to the robot the robot 1 performs the assigned task at the second location using the affixed implement until completion. When complete the robot 1 goes to either a user defined implement storage location to drop off the implement or it simply disengages where it is at the completion of the task. At this point, the procedure is performed in reverse. The robot opens the electronically activated locking devices 6 by activating the linear actuators 23 that then move the pivoting retaining member 22 so that the pins, or connection members 15, 18 are free to slide upward out of the mating hooks, or connection parts 17, 20. The robot 1 lowers the implement to the ground and continues to lower the quick hitch until the all three hooks/connection members 15, 18, 21 clear all three pins/connection parts 14, 17, 20. Once cleared and disengaged the robot drives forward to finally disengage from the implement 7.

Furthermore, the processing elements within the robot's processor 12 contribute to detection robustness by using a variety of filtering techniques on the sensory input. The tag information discerned by the processor 12 is used to drive the actuation behavior of the robot 1 as it interfaces with and uses the implement 7. Variations in implement interfaces, usage techniques, or safety considerations can be encoded in tag data and understood by the services that govern the robot's behavior and this can continually be supplemented with new data acquired through continual operation as explained above, stored, remembered and used in the future.

As taught, the robot could have manually operated connectors and locking apparatus but ideally the robot 1 uses actuators to automate all previously manual interfacing steps. As noted above, the typical apparatus to connect a tractor to the implement is a 3-point hitch, or a quick hitch 3. In one embodiment of the present invention, the quick hitch 3 utilizes the simple hook and pin system as is present in most 3-point hitch systems. The hooks as previously described are located on the body 4 that is connected to the robot 1. The hooks are engageable with the three mating pins, located on the implement 7 and previously had to be locked in place manually. In the preferred embodiment these hooks are locked in place using the electronically activated locks 6 as just described.

It should also be noted that the sensor 2 is not limited to only a camera. It could be a variety of sensors, including a camera, an infrared camera, a microphone, a thermometer, or any other type of sensor that senses distance, time, weather, terrain, field or soil conditions, or any other condition. Having a variety of sensors allows the robot to be used for a variety of other purposes aside from simply pulling an implement. For example, current weather conditions can be monitored, soil conditions can be monitored, or the robot could be used as a predator deterrent. While performing these operations the system can continually collect and learn and then apply the learning to make the system more efficient and robust. For example, if weather and soil conditions are monitored, over time the system could learn the best time of day, month, or year to perform certain tasks. It may learn that soil and weather conditions for a specific area are optimal during the first two weeks of May for planting. It may learn annual rainfall, sunset and sunrise times and soil temperature, all providing to the optimal time to plant. Soil temperatures are most ideal for planting most plants when the temperature is between 65 to 75 degrees F. and nighttime and daytime soil temperatures are both important. The system can continually record and learn soil temperatures as it works. As the system works the land it learns these conditions and ideally learns to recognize and even suggest optimal planting time. These are just a few examples and more are provided in U.S. Patent application Ser. No.: 16/024,450 filed 2018 Jun. 29 entitled AUTONOMOUS MOBILE PLATFORM WITH HARVESTING SYSTEM AND PEST AND WEED SUPPRESSION SYSTEMS.

The present invention not only teaches the apparatus but the steps and method of connecting the implement 7 to the hitch 3 as described above. The method of connection is entirely different from the current technology because it is entirely automated and because it can be performed in an unstructured environment.

In summary, the system uses a software program to employ the connection between the robot 1 and the implement 7. The robot 1 utilizes the onboard processor 11 to run the software and the onboard memory 12 to store the data. The software running on the robot 1 processes the inbound sensor data to extract the tag information whereby the system then acts on this information to navigate the robot 1 and actuate its interfaces. Thus, the system enables the robot 1 to sense and interpret tags 10, navigate in unstructured environments, and actuate the hitching interface automatically. Everything in the system is performed without human intervention.

In another embodiment, similar to the first embodiment, there is an automatic implement attachment and detachment system having a ground utility robot having a sensor, a computer processor for operating the ground utility robot, a computer memory for storing an artificial intelligence model and data, a communication unit for transmitting and receiving data to and from an external network system and device and where the sensor is configured to gather data from environments encountered by the ground utility robot. Further, an artificial intelligence processing unit is configured to train an artificial intelligence model based on received and historical data to learn to do a task, a sensor interface coupling the artificial intelligence processing unit with the sensor to provide environmental data encountered by the ground utility robot, and a user interface coupling the artificial intelligence processing unit with a user input received as data. Next, there is a quick hitch attachment apparatus having a body securable to the ground utility robot, a mateable connection part, and a connection point. This is then configured to attach to an implement where the implement has an implement body and one connection member mateably connectable to the one connection part at the connection point, where the implement attachment and detachment system automatically attaches and detaches the implement to and from the ground utility robot.

In this embodiment the automatic implement attachment and detachment system utilizes the artificial intelligence processing unit of the ground utility robot. The processing unit is configured to direct the ground utility robot to perform the task responsive to data acquired from the sensor of the ground utility robot or the user interface of the ground utility robot. Furthermore, the external network system and devices communicating with the communication unit of the ground utility robot is an artificial intelligence cloud-based system. This eliminates the need to have an on-board data storage unit and it allows communication from virtually any remote location. Thus, the operator could be located at home next to the field or across the country. It does not matter because the entire system is cloud based.

As in the first embodiment, the system learns as it works. It identifies the boundaries of its work area, it learns certain paths, routes, terrains and obstacles. It also learns where implements are, it learns to remember where they were last placed, and it learns how to find the implement. The robot learns how to locate the implement and how to automatically attach the implement to the ground utility robot. If the implement is not found because it has been moved, then the robot will communicate the lost status to the user interface. It is also possible the each implement has a transponder or some other signaling device that sends out a receivable signal whereby the robot can receive the signal, input the signal location and create a route or path to the implement using the learned data.

After the task is completed the robot will generally detach from the implement and place it in a designated location. To perform this task, the robot will search for a location to place the implement within the working area or will be assigned a position to place the implement, it will move to that location, it will position the implement for placement and it will automatically detach the implement from the ground utility robot. The placement is recorded and remembered so that when it is needed again the robot will already know where to go to collect the implement. All communication can be performed in the cloud.

As in the first embodiment, the connecting apparatus and system is the same and to avoid duplicative language the description thereof is omitted here.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items.

Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Parts Listing:
1. GUR
2. Sensor (camera, motion sensor, infrared camera, etc.)
3. Quick Hitch attachment apparatus having:
4. Body
5. Mateable connection part
6. Electrically actuated locking device
7. Implement—having:
8. 3-point attachment apparatus
9. Connection member
10. Identification tag
11. Processor
12. Memory
13. First connection point
14. First connection part
15. First connection member
16. Second connection point
17. Second connection part
18. Second connection member
19. Third connection point
20. Third connection part
21. Third connection member
22. Pivoting retaining member
23. Electric linear actuator

1. An automatic implement attachment and detachment system comprising:
a ground utility robot having
a computer processor for operating the ground utility robot;
a computer memory for storing an artificial intelligence model and data;
at least one sensor configured to gather data from environments encountered by the ground utility robot;
an artificial intelligence processing unit configured to:
train the artificial intelligence model based on received and historical data to learn to connect and disconnect an implement; and
a sensor interface coupling the artificial intelligence processing unit with the at least one sensor to provide environmental data encountered by the ground utility robot;
a quick hitch attachment apparatus comprising:
a body securable to the ground utility robot; and
at least one mateable connection part;
the implement comprising:
an implement body;
at least one connection member that is mateably connectable to the at least one
quick hitch apparatus connection part; and
wherein the implement attachment and detachment system utilizes learned and historical data to automatically attach and detach the implement to and from the ground utility robot.

2. The automatic implement attachment and detachment system of claim 1, wherein the artificial intelligence processing unit of the ground utility robot is configured to direct the ground utility robot to perform at least one task.

3. The automatic implement attachment and detachment system of claim 2, wherein the at least one task is to identify and learn boundaries of a work area to which the ground utility robot is confined.

4. The automatic implement attachment and detachment system of claim 2, wherein the at least one task:
to locate the implement based on learned and historical data within the working area;
to identify the implement by utilizing historical and learned data; and
to automatically attach the implement to the ground utility robot using the learned and historical data.

5. The automatic implement attachment and detachment system of claim 2, wherein the at least one task is:
to search for a location to place the implement within the working area;
to arrive at the location;
to position the implement for placement; and
to automatically detach the implement from the ground utility robot using the learned and historical data.

6. The automatic implement attachment and detachment system of claim 2, wherein an additional task is to determine a pathway to follow.

7. The automatic implement attachment and detachment system of claim 2, wherein another additional task is to avoid hitting objects in the pathway.

8. The automatic implement attachment and detachment system of claim 2 further comprising:
a locking device that locks the at least one connection part to the at least one connection member after mateably connecting.

9. The automatic implement attachment and detachment system of claim 8 where the at least one locking device is an electronically actuated locking mechanism.

10. The automatic implement attachment and detachment system of claim 8 having at least three connection points, comprising:
a first connection point having a first connection part located at a top of the body, connectable to a mating first connection member located at a top of the implement;
a second connection point having a second connection part located at a first lower side of the body, connectable to a mating second connection member located at lower first side of the implement; and
a third connection point having a third connection part located at a second lower side of the body, connectable to a mating third connection member located at lower second side of the implement.

11. The automatic implement attachment and detachment system of claim 10 further comprising at least two locks located at the at least two connection points to lock and secure the implement to the ground utility robot.

12. The automatic implement attachment and detachment system of claim 11 where the at least two locks are electrically actuated locks that automatically lock and secure the implement to the ground utility robot to at least two of the three connection points and automatically unlock at the same connection points when detaching the implement from the ground utility robot.

13. An automatic implement attachment and detachment system comprising:
a ground utility robot having
a sensor;
a computer processor for operating the ground utility robot;
a computer memory for storing an artificial intelligence model and data;
a communication unit for transmitting and receiving data to and from an external network system and device;
the sensor configured to gather data from environments encountered by the ground utility robot;
an artificial intelligence processing unit configured to:
train an artificial intelligence model based on received and historical data to learn to do a task;
a sensor interface coupling the artificial intelligence processing unit with the sensor to provide environmental data encountered by the ground utility robot; and
a user interface coupling the artificial intelligence processing unit with a user input received as data;
a quick hitch attachment apparatus comprising:
a body securable to the ground utility robot;
at least one mateable connection part; and
at least one connection point;
an implement comprising:
an implement body; and
at least one connection member mateably connectable to the at least one connection part at the at least one connection point; and
wherein the implement attachment and detachment system automatically attaches and detaches the implement to and from the ground utility robot.

14. The automatic implement attachment and detachment system of claim 13, wherein the artificial intelligence processing unit of the ground utility robot is configured to direct the ground utility robot to perform the task responsive to data acquired from the sensor of the ground utility robot or the user interface of the ground utility robot.

15. The automatic implement attachment and detachment system of claim 14, wherein the external network system and devices communicating with the communication unit of the ground utility robot is an artificial intelligence cloud-based system.

16. The automatic implement attachment and detachment system of claim 14, wherein the at least one task is to identify the boundaries of a work area the ground utility robot should be confined to.

17. The automatic implement attachment and detachment system of claim 16, wherein the task is a series of tasks, wherein the series of tasks are:
to search for the implement within the working area;
if the implement is found, to identify the implement by the implement's shape and size, to move towards the implement, and to automatically attach the implement to the ground utility robot; and
if not found, to communicate status to the user interface.

18. The automatic implement attachment and detachment system of claim 17, wherein the task is a series of tasks, wherein the series of tasks are:
to search for a location to place the implement within the working area;
to moving towards the location;
to position the implement for placement; and
to automatically detach the implement from the ground utility robot.

19. The automatic implement attachment and detachment system of claim 18, wherein additional tasks are to determine a pathway to follow, avoid objects, and to differentiate between living and nonliving things.

20. The automatic implement attachment and detachment system of claim 13 where the system operates in unstructured environments.
